(19) United States
(12) Patent Application Publication
(10) Pub. No.: US 2021/0155522 A1
(43) Pub. Date: May 27, 2021

(54) EXHAUST CONDUITS FOR GLASS MELT SYSTEMS

(71) Applicant: Corning Incorporated, Corning, NY (US)

(72) Inventors: Gloria Heeyeon An, Westerville, OH (US); Mark Alan Cook, Painted Post, NY (US); Raymond Eugene Fraley, Waverly, NY (US); Pierre Laronze, Corning, NY (US); John Arthur Medford, Newton, NC (US); David D Rye, Danville, KY (US)

(21) Appl. No.: 17/045,668

(22) PCT Filed: Apr. 4, 2019
(86) PCT No.: PCT/US2019/025912

§ 371 Date: Oct. 6, 2020

Related U.S. Application Data
(60) Provisional application No. 62/653,801, filed on Apr. 6, 2018.

(51) Int. Cl. C03B 5/26

(52) U.S. Cl. CPC C03B 5/26

(57) ABSTRACT

An exhaust conduit for a glass melt system includes a corrosion resistant refractory conduit material, such as a conduit material including zirconia. The conduit can extend through a relatively dense refractory block material, such as a refractory block comprising alumina. The exhaust conduit can exhibit improved corrosion resistance in processing a variety of glass melt compositions.

This application claims the benefit of priority under 35 U.S.C. § 119 of U.S. Provisional Application Ser. No. 62/653,801 filed on Apr. 6, 2018, the content of which is incorporated herein by reference in its entirety.

### FIELD

The present disclosure relates generally to exhaust conduits for glass melt systems and more particularly to exhaust conduits for glass melt systems with improved corrosion resistance.

### BACKGROUND

In the production of glass articles, such as glass sheets for display applications, including televisions and hand held devices, such as telephones and tablets, raw materials are melted into molten glass, which is, in turn, formed and cooled to make the intended glass article. During one or more stages of processing the molten glass through a glass melt system, at least a portion of an atmosphere above the molten glass may be vented through an exhaust conduit. As the atmosphere passes through the exhaust conduit, corrosive species within the atmosphere may condense on the conduit causing corrosion of the conduit. Such corrosion can ultimately result in the need to replace the conduit resulting in expense not only in terms of conduit replacement cost but also in process down time. Accordingly, it would be advantageous to design glass melt system conduits with increased corrosion resistance.

### SUMMARY

Embodiments disclosed herein include an exhaust conduit for a glass melt system. The conduit includes a refractory conduit material. The refractory conduit material has a glass melt line corrosion loss of no more than 50% relative to an alumina reference material when subjected to a Static Corrosion Test Procedure (SCTP).

Embodiments disclosed herein also include a glass melt system that includes an exhaust conduit. The conduit includes a refractory conduit material. The refractory conduit material has a glass melt line corrosion loss of no more than 50% relative to an alumina reference material when subjected to a Static Corrosion Test Procedure (SCTP).

In addition, embodiments disclosed herein include a method for producing a glass article. The method includes flowing a glass melt composition through a glass melt system. The glass melt system includes an exhaust conduit. The conduit includes a refractory conduit material. The refractory conduit material has a glass melt line corrosion loss of no more than 50% relative to an alumina reference material when subjected to a Static Corrosion Test Procedure (SCTP).

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a side cutaway view of an example exhaust conduit of a glass melting vessel extending within a refractory block;

FIG. 3. is a perspective view of the example exhaust conduit of FIG. 2;

FIG. 4 is a perspective view of example exhaust conduit having a first conduit sleeved within a second conduit;

FIG. 5 is a side cutaway view of an alternate exhaust conduit extending within a refractory block;

FIG. 6 is a side view of an alternate exhaust conduit having an angled end face extending within a refractory block;

FIG. 7 is a side cutaway view of an alternate exhaust conduit extending within a refractory block; and

FIG. 8 is a chart showing glass melt line corrosion loss of exemplary refractory materials as compared to an alumina reference material in accordance with the Static Corrosion Test Procedure (SCTP) described herein.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “glass melt composition” refers to a composition from which a glass article is made, wherein the composition may exist in any state between and including a substantially solid state and a substantially liquid state, such as any state between and including raw materials and molten glass, including any degree of partial melting there between.

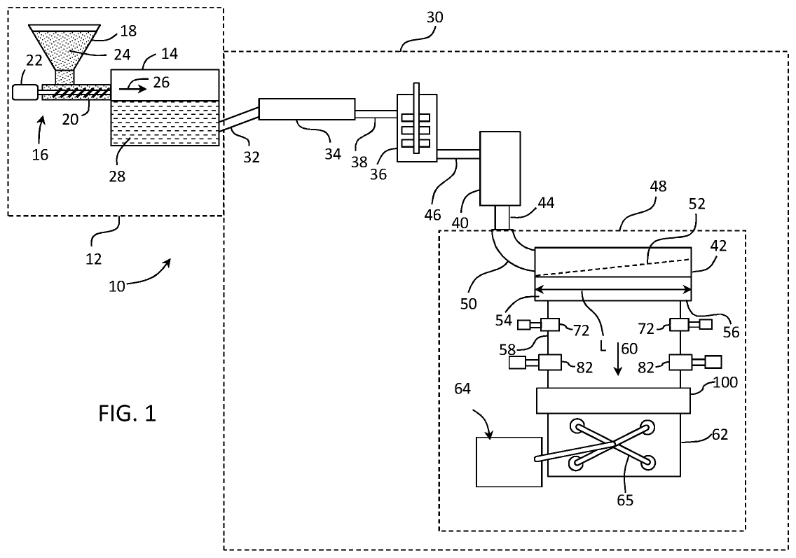

As used herein, the term “glass melt system” refers to a system through which a glass melt composition is processed. The glass melt system may include components of a glass melt furnace as described herein (e.g., with reference to FIG. 1) including, for example, a glass melting vessel. The glass melt system may also include components of a downstream glass manufacturing apparatus (e.g., with reference to FIG. 1) including, for example, connecting conduits, conditioning (fining) vessels, mixing vessels, and delivery vessels.

As used herein, the term “glass melt line corrosion loss” refers to a measured thickness reduction of a material at the interface between a specified glass melt composition and air when the material is partially immersed in the specified glass melt composition under specified conditions, such as the conditions of the Static Corrosion Test Procedure (SCTP) described herein.

As used herein, the term “Static Corrosion Test Procedure (SCTP)” refers to the specific procedure described herein wherein samples were suspended in the Experimental Glass Melt (EGM) for three days at about 1375° C. and then measured for glass melt line corrosion loss.

As used herein, the term “alumina reference material” refers to the alumina reference material tested in the Static Corrosion Test Procedure (SCTP) described herein, namely Monofrax M fused alpha-beta alumina product available from Monofrax.

As used herein, the term “stabilized zirconia” refers to a formed (e.g., by pressing, fusing, or slip casting) and fired refractory material comprising zirconia (ZrO₂) as a major component, including substantially pure zirconia and zirconia comprising at least one dopant selected from, for example, magnesium oxide (MgO), yttria (Y₂O₃), calcium oxide (CaO), and cerium (III) oxide (Ce₂O₃). Exemplary embodiments of stabilized zirconia include those having a porosity of less than about 10%, such as less than about 5%, and further such as less than about 1%.

As used herein, the term “porosity” refers to volume percentage of a material that is comprised of pore space.

As used herein, the term “thermal shock resistance” refers to the ability of a material to withstand temperature differences as defined by the thermal shock resistance parameter (TSR):

$$TSR = \frac{{σ}_{f} k}{E {α}_{l}}$$

Wherein, σ_{f} is the fracture strength, k is the thermal conductivity, E is the modulus of elasticity, and αₗ is the linear coefficient of thermal expansion of the material.

As used herein, the term coefficient of thermal expansion (CTE) refers to the thermal expansion of a material as determined ASTM C228-11.

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example in examples, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

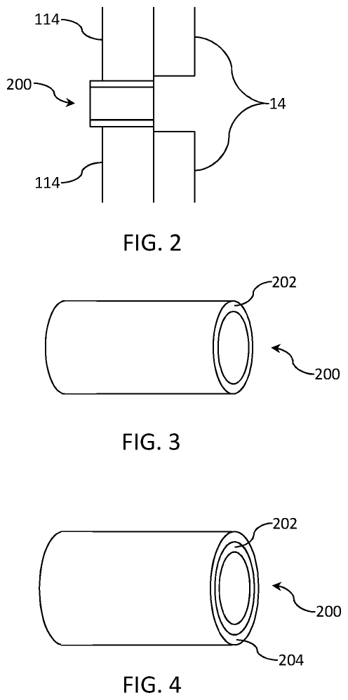

FIG. 2 shows a side cutaway view of an example exhaust conduit 200 of a glass melting vessel 14 extending within a refractory block 114. FIG. 3 shows a perspective view of the exhaust conduit 200 shown in FIG. 2, wherein the exhaust conduit has a generally cylindrical shape and comprises an exhaust conduit layer 202. As noted above, glass melting vessel 14 may be comprised of refractory material, such as a refractory ceramic material, for example a refractory ceramic material comprising at least one of alumina, silica, aluminosilicate, and zirconia, including refractory ceramic bricks.

Embodiments disclosed herein include those in which exhaust conduit 200, in operation, circumferentially surrounds an exhaust fluid flowing therethrough, such as an exhaust gas from a glass melt system, including an exhaust gas from a glass melting vessel 14. Such embodiments include those in which exhaust fluid directly physically contacts exhaust conduit 200 and further include those in which at least one material within the exhaust fluid at least temporarily condenses on exhaust conduit 200.

Embodiments disclosed herein include those in which exhaust conduit 200 comprises a refractory conduit material having a glass melt line corrosion loss of no more than 50%, such as no more than 45%, and further such as no more than 40%, including from 30% to 50%, and further such as from 35% to 45%, relative to an alumina reference material when subjected to a Static Corrosion Test Procedure (SCTP).

In certain exemplary embodiments, exhaust conduit 200 consists essentially of a refractory conduit material having a glass melt line corrosion loss of no more than 50%, such as no more than 45%, and further such as no more than 40%, including from 30% to 50%, and further such as from 35% to 45%, relative to an alumina reference material when subjected to a Static Corrosion Test Procedure (SCTP).

In certain exemplary embodiments, exhaust conduit 200, including exhaust conduit layer 202, comprises at least one of zirconia and chromium oxide. In certain exemplary embodiments, exhaust conduit 200 consists essentially of at least one of zirconia and chromium oxide.

In certain exemplary embodiments, exhaust conduit 200 comprises zirconia, such as stabilized zirconia. In certain exemplary embodiments, exhaust conduit 200 consists essentially of zirconia, such as stabilized zirconia.

Exemplary materials for exhaust conduit 200 include, but are not limited to stabilized zirconia available from CoorsTek, stabilized zirconia available from McDaniel Advanced Ceramic Technologies, isostatically pressed (isopressed) zirconia available from Zircoa, such as Zycron composition 1876 isopressed partially stabilized zirconia, Scimos CZ fused zirconia from Saint-Gobain, and C1221 chromium oxide from Saint-Gobain.

When exhaust conduit 200 comprises zirconia, such as stabilized zirconia, the zirconia can, for example, have a porosity of less than 10%, such as less than 5% and further such as less than 1%, such as between 10% and 0.1%, and further such as between 5% and 1%.

In certain exemplary embodiments, refractory conduit material has a thermal shock resistance of at least about 1×10⁴ watts/meter (W/m), such as at least about 2×10⁴ W/m, and further such as at least about 3×10⁴ W/m, including from about 1×10⁴ W/m to about 5×10⁴ W/m, such as from about 2×10⁴ W/m to about 4×10⁴ W/m.

While FIG. 2 shows the exhaust conduit 200 extending in a generally horizontal direction, it is to be understood that embodiments herein include those in which exhaust conduit 200 extends in other directions, such as a generally vertical direction. In addition, while FIG. 3 shows exhaust conduit 200 having a generally cylindrical shape or circular cross section, it is to be understood that embodiments herein include those in which the exhaust conduit has other shapes or cross sections, including elliptical and rectangular cross-sections.

Refractory block 114 can, for example, have a density of at least 3 grams/cubic centimeter (g/cc), such as at least 3.5 g/cc, including between about 3 g/cc and 5 g/cc. In certain exemplary embodiments, refractory block 114 comprises or consists essentially of alumina, such as alpha and/or beta alumina, formed by, for example, fusion casting, isopressing, uniaxial pressing, or slip casting, such as, for example, Monofrax M alpha-beta alumina, Monofrax A-2 alpha alumina, and Monofrax H beta alumina available from Monofrax LLC as well as Scimos A alpha alumina available from Saint-Gobain. Refractory block 114 may also comprise other materials such as zircon, spinel, silica, mullite, and various aluminosilicates, including alumina zirconia silicates (AZS).

Embodiments disclosed herein include those in which the coefficient of thermal expansion (CTE) of the refractory conduit material does not differ substantially from the CTE of the refractory block, such as embodiments wherein the CTE of the refractory conduit material is within 20% of the CTE of the refractory block, such as from within 1% to 20% of the CTE of the refractory block.

FIG. 4 shows a perspective view of an example exhaust conduit 2002 having a first conduit layer 202 sleeved within a second conduit layer 204. First and second conduit layers 202, 204, can be comprised of the same or different materials and can have the same or different radial thicknesses. When first and second conduit layers, 202, 204, are comprised of different materials, embodiments disclosed herein include those in which the CTE of first conduit layer 202 does not differ substantially from the CTE of the second conduit layer 204, such as embodiments wherein the CTE of the first conduit layer 202 is within about 20% of the CTE of the second conduit layer 204.

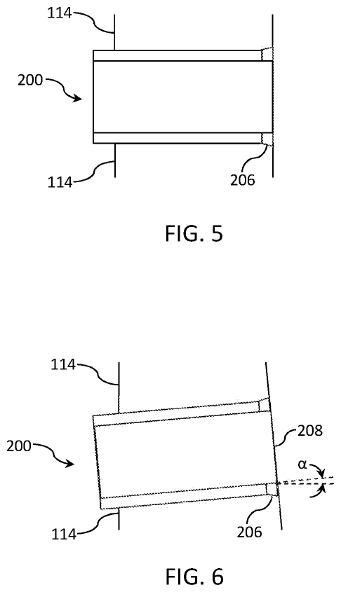

FIG. 5 shows a side view of an alternate exhaust conduit 200 extending within a refractory block 114, wherein exhaust conduit 200 comprises an outwardly flanged end region 206. Flanged end region 206 can help prevent condensed liquids from flowing between exhaust conduit 200 and refractory block 114.

FIG. 6 shows a side view of an alternate configuration wherein exhaust conduit 200 extends within a refractory block 114 in an angled arrangement. Refractory block 114 also has an angled face that is generally parallel to the angled end face 208 of exhaust conduit 200. While not limited, the exhaust conduit 200 can angle downward in a direction away from melting vessel 14 at an angle, u, ranging from about 2 degrees to about 10 degrees, such as from about 3 degrees to about 8 degrees. Angling the position of exhaust conduit 200 can enable condensation from melting vessel 14 to more easily flow through and out of exhaust conduit 200.

While exhaust conduit 200 is shown in FIG. 6 as having an outwardly flanged end region 206, it is to be understood that embodiments disclosed herein include those in which exhaust conduit 200 is in an angled arrangement but does not include an outwardly flanged end region 206. In addition, while angled end face 208 is shown in FIG. 6 as being generally parallel to angled face of refractory block 114, it is to be understood that embodiments disclosed herein include those in which angled end face 208 is not generally parallel to a face of refractory block 114 and further includes those in which angled end face 208 is not in the same plane as a face of refractory block 114 (such as where a face of refractory block 114 extends closer to melting vessel 14 than angled end face 208 and vice versa).

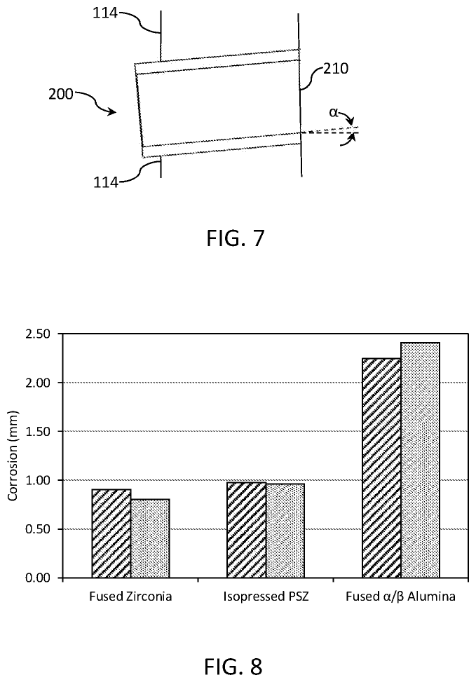

FIG. 7 shows a side cutaway view of an alternate exhaust conduit 200 extending within a refractory block 114 having two parallel faces wherein a longitudinal axis of the exhaust conduit 200 is not perpendicular to the two faces (i.e., the exhaust conduit 200 angles downward in a direction away from melting vessel 14 at an angle α) but at least one end 210 of the conduit is configured to be parallel to the two faces.

Embodiments disclosed herein also include glass melt systems comprising exhaust conduits as described herein, including glass melt systems comprising exhaust conduits extending through refractory blocks as described herein. In addition, embodiments disclosed herein include methods for producing glass articles comprising flowing glass melt compositions through such glass melt systems.

For example, embodiments disclosed herein can be used for producing commercially available glasses such as EAGLE XG®, Lotus™, Willow®, Iris™, and Gorilla® glasses from Corning Incorporated.

Some non-limiting glass compositions can include between about 50 mol % to about 90 mol % SiO₂, between 0 mol % to about 20 mol % Al₂O₃, between 0 mol % to about 20 mol % B₂O₃, and between 0 mol % to about 25 mol % RₓO, wherein R is any one or more of Li, Na, K, Rb, Cs and x is 2, or Zn, Mg, Ca, Sr or Ba and x is 1. In some embodiments, RₓO—Al₂O₃>0; 0<RₓO—Al₂O₃<15; x=2 and R₂O—Al₂O₃<15; R₂O—Al₂O₃<2; x=2 and R₂O—Al₂O₃—MgO>−15; 0<(RₓO—Al₂O₃)<25, −11<(R₂O—Al₂O₃)<11, and −15<(R₂O—Al₂O₃—MgO)<11; and/or −1<(R₂O—Al₂O₃)<2 and −6<(R₂O—Al₂O₃—MgO)<1. In some embodiments, the glass comprises less than 1 ppm each of Co, Ni, and Cr. In some embodiments, the concentration of Fe is <about 50 ppm, <about 20 ppm, or <about 10 ppm. In other embodiments, Fe+30Cr+35Ni<about 60 ppm, Fe+30Cr+35Ni<about 40 ppm, Fe+30Cr+35Ni<about 20 ppm, or Fe+30Cr+35Ni<about 10 ppm. In other embodiments, the glass comprises between about 60 mol % to about 80 mol % SiO₂, between about 0.1 mol % to about 15 mol % Al₂O₃, 0 mol % to about 12 mol % B₂O₃, and about 0.1 mol % to about 15 mol % Rₓ, wherein R is any one or more of Li, Na, K, Rb, Cs and x is 2, or Zn, Mg, Ca, Sr or Ba and x is 1.

Glass compositions comprising at least 0.1 mol % alkali metal oxide (i.e., RₓO, wherein R is any one or more of Li, Na, K, Rb, Cs), may comprise at least 0.5 mol % alkali metal oxide, such as at least 1.0 mol % alkali metal oxide. For example, in some embodiments, the glass composition can comprise between about 65.79 mol % to about 78.17 mol % SiO₂, between about 2.94 mol % to about 12.12 mol % Al₂O₃, between about 0 mol % to about 11.16 mol % B₂O₃, between about 0 mol % to about 2.06 mol % Li₂O, between about 3.52 mol % to about 13.25 mol % Na₂O, between about 0 mol % to about 4.83 mol % K₂O, between about 0 mol % to about 3.01 mol % ZnO, between about 0 mol % to about 8.72 mol % MgO, between about 0 mol % to about 4.24 mol % CaO, between about 0 mol % to about 6.17 mol % SrO, between about 0 mol % to about 4.3 mol % BaO, and between about 0.07 mol % to about 0.11 mol % SnO₂.

In additional embodiments, the glass can comprise an RₓO/Al₂O₃ ratio between 0.95 and 3.23, wherein R is any one or more of Li, Na, K, Rb, Cs and x is 2. In further embodiments, the glass may comprise an RₓO/Al₂O₃ ratio between 1.18 and 5.68, wherein R is any one or more of Li, Na, K, Rb, Cs and x is 2, or Zn, Mg, Ca, Sr or Ba and x is 1. In yet further embodiments, the glass can comprise an RₓO—Al₂O₃— MgO between −4.25 and 4.0, wherein R is any one or more of Li, Na, K, Rb, Cs and x is 2. In still further embodiments, the glass may comprise between about 66 mol % to about 78 mol % SiO₂, between about 4 mol % to about 11 mol % Al₂O₃, between about 4 mol % to about 11 mol % B₂O₃, between about 0 mol % to about 2 mol % Li₂O, between about 4 mol % to about 12 mol % Na₂O, between about 0 mol % to about 2 mol % K₂O, between about 0 mol % to about 2 mol % ZnO, between about 0 mol % to about 5 mol % MgO, between about 0 mol % to about 2 mol % CaO, between about 0 mol % to about 5 mol % SrO, between about 0 mol % to about 2 mol % BaO, and between about 0 mol % to about 2 mol % SnO₂.

In additional embodiments, the glass can comprise between about 72 mol % to about 80 mol % SiO₂, between about 3 mol % to about 7 mol % Al₂O₃, between about 0 mol % to about 2 mol % B₂O₃, between about 0 mol % to about 2 mol % Li₂O, between about 6 mol % to about 15 mol % Na₂O, between about 0 mol % to about 2 mol % K₂O, between about 0 mol % to about 2 mol % ZnO, between about 2 mol % to about 10 mol % MgO, between about 0 mol % to about 2 mol % CaO, between about 0 mol % to about 2 mol % SrO, between about 0 mol % to about 2 mol % BaO, and between about 0 mol % to about 2 mol % SnO₂. In certain embodiments, the glass can comprise between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein Fe+30Cr+35Ni<about 60 ppm.

### EXAMPLES

Embodiments disclosed herein are further illustrated by the following non-limiting examples.

Static Corrosion Test Procedure (SCTP)

The SCTP was performed by partially suspending a finger of an exemplary or alumina reference refractory material into the Experimental Glass Melt (EGM) composition described herein. Specifically, 300 grams of the EGM was pre-melted in a 200 cubic centimeter platinum crucible after which a finger of exemplary or alumina reference refractory material was suspended in the EGM for three days at about 1375° C. The dimensions of the exemplary and alumina reference material fingers were each about 10 millimeters×10 millimeters×50 millimeters. Following suspension in the EGM, the exemplary and alumina reference material fingers were removed from the crucibles, cross-sectioned lengthwise and measured for glass melt line corrosion loss (i.e., the measured thickness reduction of each finger at the interface between the EGM and air as a result of the fingers being suspended in the EGM).

Experimental Glass Melt (EGM)

The EGM was a commercially-available, soda-lime-silicate float cullet available from Guardian Industries Corporation having a composition as shown in Table 1:

TABLE 1

| Component | Weight % |
|---|---|
| SiO₂ | 70-74 |
| Na₂O | 12-16 |
| CaO | 8-13 |
| MgO | 0-5 |
| Al₂O₃ | 0-2 |
| K₂O | 0-0.5 |
| SO₃ | >0.2 |
| Fe₂O₃ | 0.01-1.5 |

Exemplary refractory materials subjected to the SCTP included Composition 1876 isopressed partially stabilized zirconia available from Zircoa and Scimos CZ fused zirconia from Saint-Gobain. The alumina reference material was Monofrax M fused alpha-beta alumina product available from Monofrax. Two samples of each refractory reference material and two samples of alumina reference material were subjected to the SCTP, with the results shown in FIG. 8.

Specifically, FIG. 8 shows glass melt line corrosion loss of the two exemplary refractory materials as compared to the alumina reference material in accordance with the Static Corrosion Test Procedure (SCTP) described herein. As can be seen from FIG. 8, each of the exemplary refractory materials (Scimos CZ and Composition 1876) subjected to the SCTP exhibited a glass melt line corrosion loss of less than 1 millimeter whereas the alumina reference material subjected to the SCTP exhibited a glass melt corrosion loss of more than 2 millimeters. Accordingly, each of the exemplary refractory materials subjected to the SCTP exhibited a glass melt line corrosion loss of no more than 50% and, specifically, less than 50%, relative to the alumina reference material subjected to the SCTP.

Embodiments disclosed herein can enable more corrosion-resistant conduits in the processing of glass melt compositions in glass melt systems, including situations where an atmosphere, such as an exhaust atmosphere of a glass melt, may condense on the conduit. Such increased corrosion resistance can reduce the frequency of need to replace such conduits, resulting in decreased conduit replacement costs and process down time.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

1. An exhaust conduit for a glass melt system, the exhaust conduit comprising a refractory conduit material having a glass melt line corrosion loss of no more than 50% relative to an alumina reference material when subjected to a Static Corrosion Test Procedure (SCTP).

2. The exhaust conduit of claim 1, wherein the refractory conduit material comprises zirconia.

3. The exhaust conduit of claim 2, wherein the zirconia has a porosity of less than about 10%.

4. The exhaust conduit of claim 1, wherein the exhaust conduit extends within a refractory block having a density of at least 3 g/cc.

5. The exhaust conduit of claim 1, wherein the refractory block comprises alumina.

6. The exhaust conduit of claim 1, wherein the refractory conduit material has a thermal shock resistance of at least about 1×10⁴ W/m.

7. The exhaust conduit of claim 1, wherein the coefficient of thermal expansion (CTE) of the refractory conduit material is within 20% of the CTE of the refractory block.

8. The exhaust conduit of claim 1, wherein the conduit comprises a first conduit sleeved within a second conduit.

9. The exhaust conduit of claim 4, wherein the conduit extends in an angled arrangement relative to horizontal.

10. A glass melt system comprising an exhaust conduit, the exhaust conduit comprising a refractory conduit material having a glass melt line corrosion loss of no more than 50% relative to an alumina reference material when subjected to a Static Corrosion Test Procedure (SCTP).

11. The glass melt system of claim 10, wherein the refractory conduit material comprises zirconia.

12. The glass melt system of claim 10, wherein the exhaust conduit extends within a refractory block having a density of at least 3 g/cc.

13. The glass melt system of claim 12, wherein the refractory block comprises alumina.

14. The glass melt system of claim 10, wherein the refractory conduit material has a thermal shock resistance of at least about 1×10⁴ W/m.

15. A method for producing a glass article comprising flowing a glass melt composition through a glass melt system, the glass melt system comprising an exhaust conduit, the exhaust conduit comprising a refractory conduit material having a glass melt line corrosion loss of no more than 50% relative to an alumina reference material when subjected to a Static Corrosion Test Procedure (SCTP).

16. The method of claim 15, wherein the refractory conduit material comprises zirconia.

17. The method of claim 15, wherein the exhaust conduit extends within a refractory block having a density of at least 3 g/cc.

18. The method of claim 17, wherein the refractory block comprises alumina.

19. The method of claim 15, wherein the refractory conduit material has a thermal shock resistance of at least about 1×10⁴ W/m.

20. The method of claim 15, wherein the glass melt composition comprises at least 0.1 mol % alkali metal oxide.
